(19) United States
(12) Patent Application Publication
(10) Pub. No.: US 2011/0111176 A1
(43) Pub. Date: May 12, 2011

(54) SHELL BODY WITH A PLASTIC MEMBER MOLDED ONTO A GLASS PANEL, AND METHOD FOR MANUFACTURING THE SHELL BODY

(75) Inventors: Shao-Chen CHIU, Taichung County (TW); Shang-Ming LIN, Taichung County (TW); Wei-Chuan CHUANG, Taichung County (TW); Chia-Hsiu HO, Taichung County (TW)

(73) Assignee: TAIWAN GREEN POINT ENTERPRISES CO., LTD., Taichung County (TW)

(21) Appl. No.: 12/938,036

(22) Filed: Nov. 2, 2010

Related U.S. Application Data
(60) Provisional application No. 61/259,216, filed on Nov. 9, 2009.

(51) Int. Cl. B32B 3/02; B29C 47/02; B44C 1/22

(52) U.S. Cl. 428/157; 264/279; 216/52

(57) ABSTRACT

A method for manufacturing a shell body includes the steps of: a) processing a glass substrate to form a glass panel having a top surface, a bottom surface, and a peripheral face extending between the top and bottom surfaces, the peripheral face being formed with a coupling portion, the coupling portion being one of a protrusion protruding from the peripheral face and a recess indented from the peripheral face; and b) molding a plastic member onto the glass panel, the plastic member being coupled fittingly to the coupling portion of the glass panel. A shell body with a plastic member molded onto a glass panel is also disclosed.

### CROSS-REFERENCE TO RELATED APPLICATION

This application claims priority from U.S. Provisional Patent Application No. 61/259,216, filed on Nov. 9, 2009.

### BACKGROUND OF THE INVENTION

1. Field of the Invention

The invention relates to a shell body, and more particularly to a shell body with a plastic member molded onto a glass panel. The invention also relates to a method for manufacturing the shell body.

2. Description of the Related Art

There are always new designs for consumer portable electronics products. A glass material is one of the materials preferred by consumers in view of the smooth appearance and high hardness thereof. However, it is relatively difficult to effectively bond the glass material to other materials, such as plastic, because of the smoothness thereof.

Conventionally, the glass and plastic materials are bonded together using an adhesive, which results in a complicated manufacturing procedure and increased production costs. Furthermore, such a bonding manner using adhesive reduces flexibility in the design of the consumer portable electronics products.

In view of the aforesaid, it is desirable in the art of manufacturing consumer portable electronics products to provide an improved method for bonding a plastic material to a glass material without using adhesive.

In U.S. Pat. No. 6,783,347, a peripherally encapsulated product, such as an oven door outer shell, is molded by placing a piece of glass between mold clamping portions of relatively movable closed bodies. Thermosetting polymeric material is placed upon selected areas of one of the mold bodies within and about an area corresponding to an annular mold cavity and outboard of a peripheral edge of a piece of glass. The glass is clamped between mold clamping portions of the mold bodies which are then progressively closed creating compression forces which extrude the thermosetting polymeric material into the annular cavity and into complete encapsulation of the continuous peripheral edge of the piece of glass.

U.S. Pat. No. 6,120,720 is directed to the injection molding of a polymeric/copolymeric frame about a peripheral edge of glass panel in association with a pair of brackets to form a refrigerator shelf.

In the methods disclosed in these two U.S. documents, the polymeric material completely encapsulates the whole peripheral edge of the piece of glass, and thus the thickness of the molding polymeric frame is larger than that of the piece of glass. The methods disclosed in the U.S. documents are not suitable for making consumer portable electronics products.

### SUMMARY OF THE INVENTION

An object of the present invention is to provide a method for manufacturing a shell body which is relatively simple and which provides sufficient bonding strength between the plastic and glass materials without using adhesive.

Another object of the present invention is to provide a shell body manufactured by the method of the present invention.

In one aspect of this invention, a method for manufacturing a shell body includes the steps of: a) processing a glass substrate to form a glass panel having a top surface, a bottom surface, and a peripheral face extending between the top and bottom surfaces, the peripheral face being formed with a coupling portion, the coupling portion being one of a protrusion protruding from the peripheral face and a recess indented from the peripheral face; and b) molding a plastic member onto the glass panel, the plastic member being coupled fittingly to the coupling portion of the glass panel.

In another aspect of this invention, a shell body includes a glass panel and a plastic member. The glass panel has a top surface, a bottom surface, a peripheral face extending between the top and bottom surfaces, and a coupling portion formed at the peripheral face. The coupling portion is one of a protrusion protruding from the peripheral face and a recess indented from the peripheral face. The plastic member is molded onto the glass panel and is coupled fittingly to the coupling portion of the glass panel.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 illustrates consecutive steps for manufacturing a first preferred embodiment of a shell body according to the present invention;

FIG. 2 is a top view of a glass panel used in the preferred embodiment;

FIG. 3 is a fragmentary sectional view of a second preferred embodiment of a shell body according to the present invention;

FIG. 4 is a fragmentary sectional view of a third preferred embodiment of a shell body according to the present invention;

FIG. 5 is a fragmentary sectional view of a fourth preferred embodiment of a shell body according to the present invention; and

FIG. 6 is a fragmentary sectional view of a fifth preferred embodiment of a shell body according to the present invention.

### DETAILED DESCRIPTION OF THE PREFERRED EMBODIMENTS

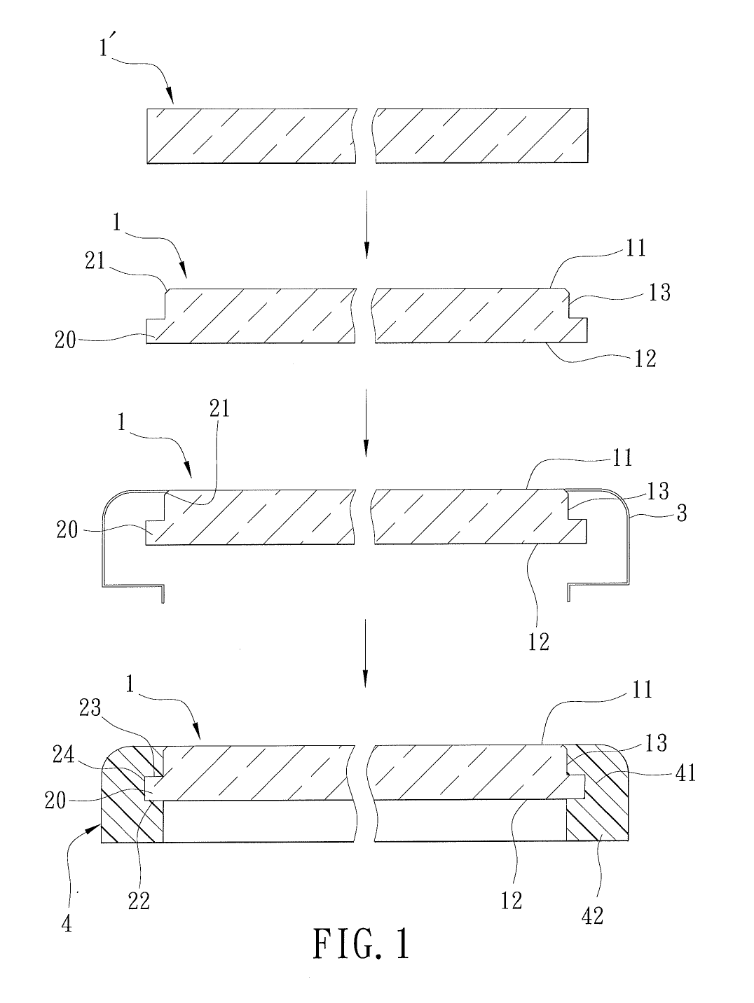

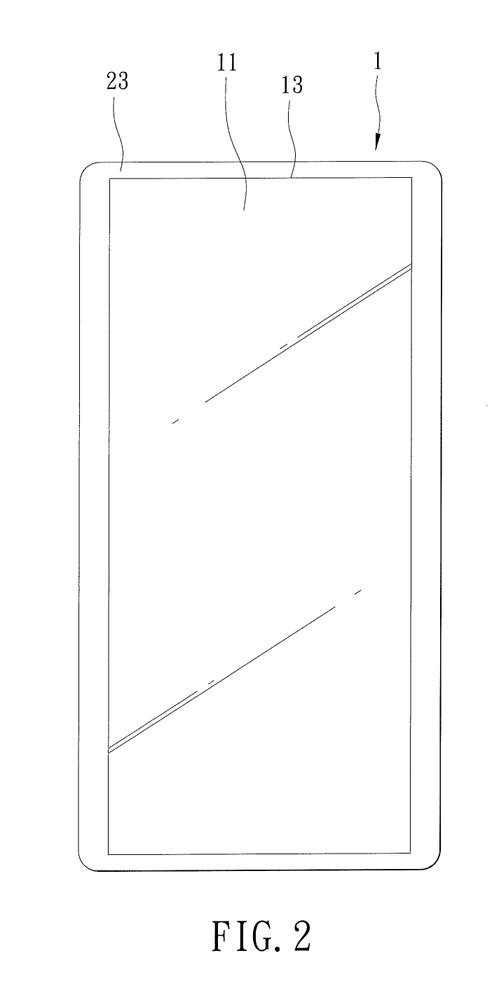

Referring to FIGS. 1 and 2, the preferred embodiment of a method for manufacturing a shell body according to this invention includes the steps of:

### A) Processing a Glass Substrate to Form a Glass Panel:

A glass substrate 1′ is processed to form a glass panel 1, which has a top surface 11, a bottom surface 12, and a peripheral face 13 extending between the top and bottom surfaces 11, 12. The peripheral face 13 is formed with a coupling portion 20. The coupling portion 20 can be a protrusion protruding from the peripheral face 13 or a recess indented from the peripheral face 13. In this preferred embodiment, the coupling portion 20 is a protrusion, i.e., a portion of the glass material extending from the main body in a one-piece continuously formed construction. Preferably, the glass panel 1 is further formed with a peripheral cut edge 21 between the top surface 11 and the peripheral face 13. The coupling portion 20 and the peripheral cut edge 21 can be formed using one of laser etching and lathing techniques, for example, in a computer numerical control manner. Moreover, the glass panel 1 can be reinforced by chemical tempering. The glass panel 1 after the chemical tempering has a surface stress of 650 Mpa and a reinforcement depth of 10 μm.

### B) Molding a Plastic Member:

The glass panel 1 is received in a mold 3 in a manner that the coupling portion 20 is disposed in the mold 3. A plastic member 4 is molded onto the glass panel 1, for example, by injection molding of a plastic material. The plastic member 4 is coupled fittingly to the coupling portion 20 of the glass panel 1 such that the coupling portion 20 and/or the plastic member 4 form a catch that captures each other to form a secure bond therebetween. A shell body is obtained after cooling the plastic member 4 and removing the mold 3. In the shell body thus obtained, the plastic member 4 is coupled fittingly to the coupling portion 20 of the glass panel 1 without using adhesive.

Specifically referring to FIG. 1, the first preferred embodiment of a shell body according to the present invention includes the glass panel 1 and the plastic member 4.

The glass panel 1 has the top surface 11, the bottom surface 12, the peripheral face 13 extending between the top and bottom surfaces 11,12, and the coupling portion 20 formed at the peripheral face 13. The coupling portion 20 is a protrusion protruding from the peripheral face 13. The protrusion has first and second faces 22,23 extending transversely from the peripheral face 13, and a third face 24 extending between the first and second faces 22,23. The first face 22 of the protrusion is flush with the bottom surface 12 of the glass panel 1.

The plastic member 4 is molded onto the glass panel 1 and is coupled fittingly to the coupling portion 20 of the glass panel 1. The plastic member 4 includes an engaging portion 41 coupled fittingly to the coupling portion 20 of the glass panel 1, and a wall portion 42 extending from the engaging portion 41 and transverse to the bottom surface 12 of the glass panel 1.

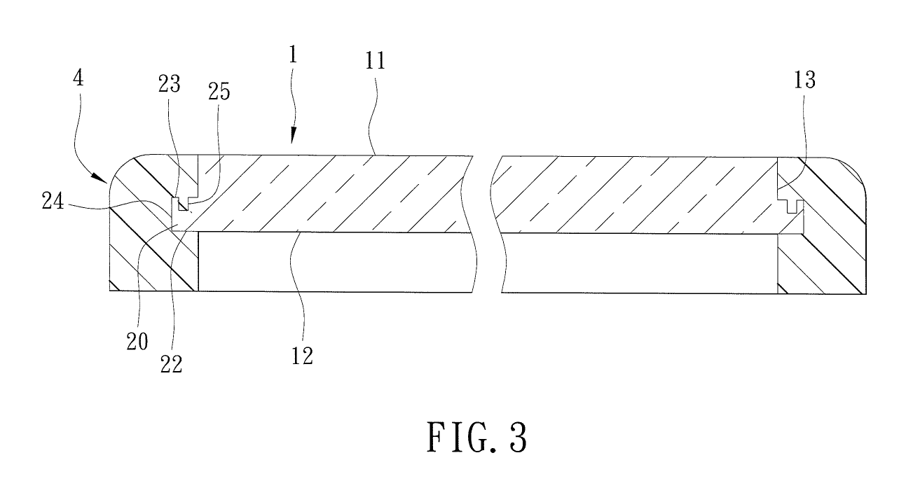

Referring to FIG. 3, the second preferred embodiment of a shell body according to the present invention is similar to the first preferred embodiment except that the protrusion has a groove 25 recessed from the second face 23 and filled by the plastic member 4.

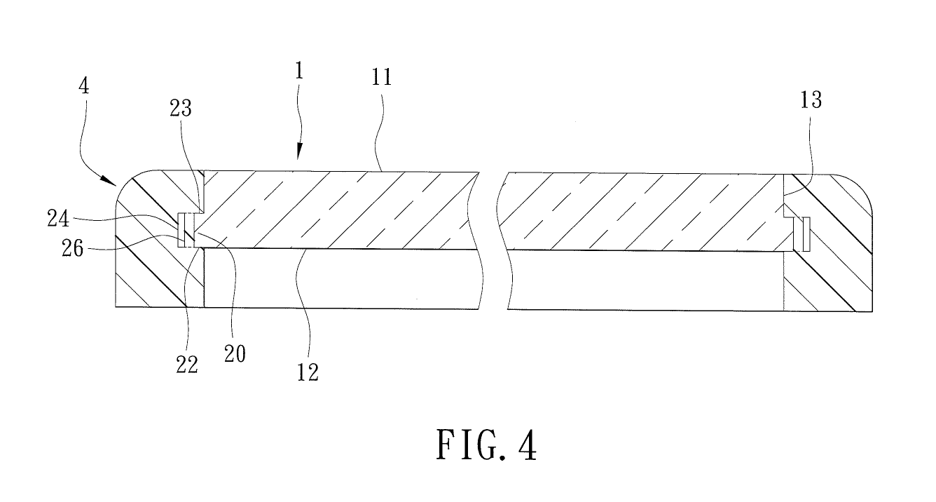

Referring to FIG. 4, the third preferred embodiment of a shell body according to the present invention is similar to the first preferred embodiment except that the protrusion has a through hole 26 extending between the first and second faces 22,23 and filled by the plastic member 4.

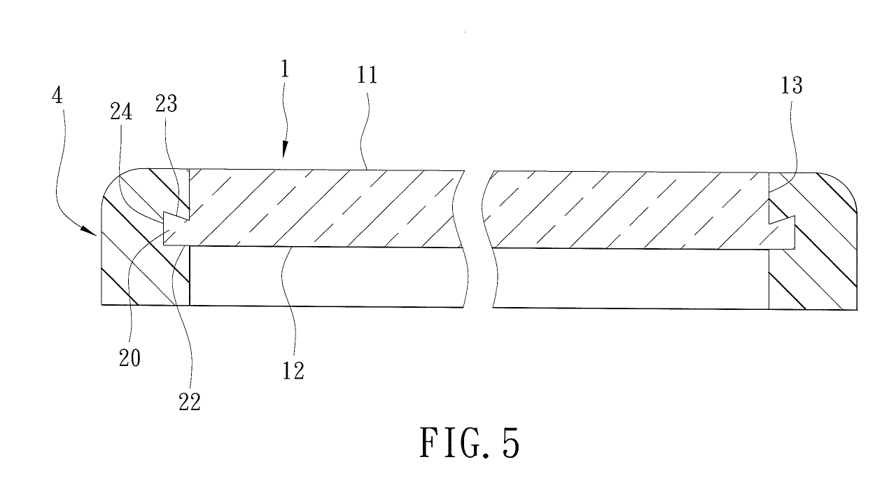

Referring to FIG. 5, the fourth preferred embodiment of a shell body according to the present invention is similar to the first preferred embodiment except that the protrusion has a generally dovetail-shaped cross-section. Specifically, the protrusion has the first face 22 extending transversely from the peripheral face 13 and flush with the bottom face 12 of the glass panel 1, the second face 23 extending inclinedly from the peripheral face 13 in a direction away from the first face 22, and the third face 24 extending between the first and second faces 22,23.

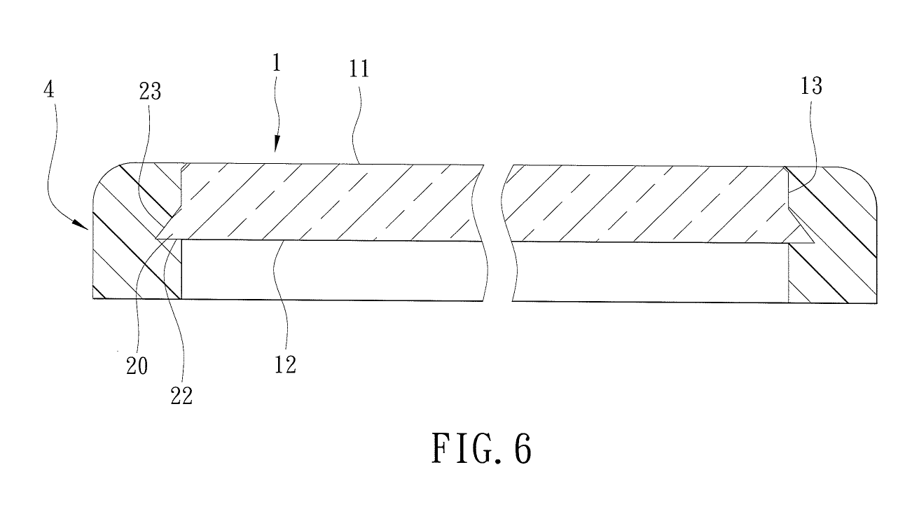

Referring to FIG. 6, the fifth preferred embodiment of a shell body according to the present invention is similar to the first preferred embodiment except that the protrusion has a wedge-shaped cross-section. Specifically, the protrusion has the first face 22 extending transversely from the peripheral face 13 and flush with the bottom face 12 of the glass panel 1, and the second face 23 extending inclinedly from the peripheral face 13 and connected to the first face 22.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A method for manufacturing a shell body, comprising the steps of:
a) processing a glass substrate to form a glass panel having a top surface, a bottom surface, and a peripheral face extending between the top and bottom surfaces, the peripheral face being formed with a coupling portion, the coupling portion being one of a protrusion protruding from the peripheral face and a recess indented from the peripheral face; and
b) molding a plastic member onto the glass panel, the plastic member being coupled fittingly to the coupling portion of the glass panel.

2. The method as claimed in claim 1, wherein the glass substrate is processed in step a) using one of laser etching and lathing techniques.

3. The method as claimed in claim 1, further comprising the step of subjecting the glass panel to chemical tempering prior to step b).

4. The method as claimed in claim 1, wherein the glass panel is received in a mold in the step b) in a manner that the coupling portion is disposed in the mold.

5. A shell body comprising:
a glass panel having a top surface, a bottom surface, a peripheral face extending between said top and bottom surfaces, and a coupling portion formed at said peripheral face, said coupling portion being one of a protrusion protruding from said peripheral face and a recess indented from said peripheral face; and
a plastic member molded onto said glass panel and coupled fittingly to said coupling portion of said glass panel.

6. The shell body as claimed in claim 5, wherein said plastic member includes an engaging portion coupled fittingly to said coupling portion of said glass panel, and a wall portion extending from said engaging portion and transverse to said bottom surface of said glass panel.

7. The shell body as claimed in claim 5, wherein said coupling portion is said protrusion.

8. The shell body as claimed in claim 7, wherein said protrusion has first and second faces extending transversely from said peripheral face, and a third face extending between said first and second faces.

9. The shell body as claimed in claim 8, wherein said first face of said protrusion is flush with said bottom surface of said glass panel.

10. The shell body as claimed in claim 9, wherein said protrusion has at least one groove recessed from said second face and filled by said plastic member.

11. The shell body as claimed in claim 9, wherein said protrusion has at least one through hole extending between said first and second faces and filled by said plastic member.

12. The shell body as claimed in claim 7, wherein said protrusion has a generally dovetail-shaped cross-section.

13. The shell body as claimed in claim 7, wherein said protrusion has a first face extending transversely from said peripheral face, a second face extending inclinedly from said peripheral face in a direction away from said first face, and a third face extending between said first and second faces.

14. The shell body as claimed in claim 13, wherein said first face of said protrusion is flush with said bottom face of said glass panel.

15. The shell body as claimed in claim 7, wherein said protrusion has a wedge-shaped cross-section.

16. The shell body as claimed in claim 7, wherein said protrusion has a first face extending transversely from said peripheral face, and a second face extending inclinedly from said peripheral face and connected to said first face.

17. The shell body as claimed in claim 16, wherein said first face is flush with said bottom face of said glass panel.
